(19) United States
(12) Patent Application Publication
(10) Pub. No.: US 2023/0262733 A1
(43) Pub. Date: Aug. 17, 2023

(54) PHASE TRACKING REFERENCE SIGNAL CONFIGURATION FOR BROADCAST AND MULTICAST WIRELESS COMMUNICATIONS

(71) Applicant: QUALCOMM Incorporated, San Diego, CA (US)

(72) Inventors: Tianyang Bai, Somerville, NJ (US); Hua Wang, Basking Ridge, NJ (US); Jung Ho Ryu, Fort Lee, NJ (US); Junyi Li, Fairless Hills, PA (US)

(21) Appl. No.: 17/670,276

(22) Filed: Feb. 11, 2022

(51) Int. Cl. H04W 72/00; H04L 5/00; H04W 4/06; H04W 28/18

(52) U.S. Cl. CPC H04W 72/005; H04L 5/0048; H04W 4/06; H04W 28/18

(57) ABSTRACT

Methods, systems, and devices for wireless communications are described. A communication device (e.g., network entity, multiple user equipments (UEs)) may determine a phase tracking reference signal (PTRS) configuration for multiple UEs. The multiple UEs may receive a PTRS signal and data communication intended for the multiple UEs based on the determined PTRS configuration. In some examples, the multiple UEs may be known to the network entity as a group of UEs and the network entity may determine the PTRS configuration based on a condition of the group of UEs, a condition of each UE of the group of UEs, or both. The network entity may transmit the PTRS configuration to the group of UEs.

### FIELD OF TECHNOLOGY

The following relates to wireless communications, including phase tracking reference signal (PTRS) configuration for broadcast and multicast wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE).

### SUMMARY

Generally, the described techniques provide procedures for a PTRS configuration for broadcast and multicast communications. The techniques enable a wireless communication device (e.g., a network entity) to determine a PTRS configuration associated with a data communication for multiple UEs. For example, a network entity may determine that a data communication includes data intended for multiple UEs. The network entity, the multiple UEs, or both, may determine a PTRS configuration (e.g., a PTRS table separate from a unicast PTRS table) for the multiple UEs (e.g., based on a condition of the multiple UEs, a default configuration, etc.). The multiple UEs may receive a PTRS signal and the data communication based on the determined PTRS configuration. In some examples, the multiple UEs may be known to the network entity as a group of UEs and the network entity may determine the PTRS configuration based on a condition of the group of UEs, a condition of each UE of the group of UEs, or both. The network entity may transmit the PTRS configuration to the group of UEs.

A method for wireless communication at a UE is described. The method may include determining a PTRS configuration associated with data communication for a set of multiple UEs, the data communication including a broadcast data communication, a multicast data communication, a groupcast data communication, or any combination thereof, receiving a PTRS based on the determined PTRS configuration, and receiving the data communication based on the determined PTRS configuration.

An apparatus for wireless communication at a UE is described. The apparatus may include a processor, and a memory coupled with the processor, with instructions stored in the memory, the instructions being executable by the processor to cause the apparatus to determine a PTRS configuration associated with data communication for a set of multiple UEs, the data communication including a broadcast data communication, a multicast data communication, a groupcast data communication, or any combination thereof, receive a PTRS based on the determined PTRS configuration, and receive the data communication based on the determined PTRS configuration.

Another apparatus for wireless communication at a UE is described. The apparatus may include means for determining a PTRS configuration associated with data communication for a set of multiple UEs, the data communication including a broadcast data communication, a multicast data communication, a groupcast data communication, or any combination thereof, means for receiving a PTRS based on the determined PTRS configuration, and means for receiving the data communication based on the determined PTRS configuration.

A non-transitory computer-readable medium storing code for wireless communication at a UE is described. The code may include instructions executable by a processor to determine a PTRS configuration associated with data communication for a set of multiple UEs, the data communication including a broadcast data communication, a multicast data communication, a groupcast data communication, or any combination thereof, receive a PTRS based on the determined PTRS configuration, and receive the data communication based on the determined PTRS configuration.

In some examples of the method, apparatuses, and non-transitory computer-readable medium described herein, receiving the PTRS may include operations, features, means, or instructions for receiving, from a network entity, a broadcast message including the PTRS based on the broadcast data communication.

In some examples of the method, apparatuses, and non-transitory computer-readable medium described herein, receiving the PTRS may include operations, features, means, or instructions for receiving, from a network entity, a multicast message, a groupcast message, or both, including the PTRS based on the multicast data communication, the groupcast data communication, or both.

Some examples of the method, apparatuses, and non-transitory computer-readable medium described herein may further include operations, features, means, or instructions for receiving, from a network entity, a broadcast message indicating the PTRS configuration.

Some examples of the method, apparatuses, and non-transitory computer-readable medium described herein may further include operations, features, means, or instructions for receiving, from a network entity, a first multicast message, a first groupcast message, or both, indicating the PTRS configuration for a group of UEs of the set of multiple UEs, the group of UEs including at least a subset of the set of multiple UEs.

Some examples of the method, apparatuses, and non-transitory computer-readable medium described herein may further include operations, features, means, or instructions for receiving the PTRS configuration may be based on an admittance to a subscription of the group of UEs.

Some examples of the method, apparatuses, and non-transitory computer-readable medium described herein may further include operations, features, means, or instructions for transmitting a capability report indicating a PTRS capability or a preferred PTRS configuration and where determining the PTRS configuration may be based on the capability report.

Some examples of the method, apparatuses, and non-transitory computer-readable medium described herein may further include operations, features, means, or instructions for transmitting, to the network entity, feedback associated with the PTRS configuration, where the feedback includes a decoding failure cause associated with the data communication.

Some examples of the method, apparatuses, and non-transitory computer-readable medium described herein may further include operations, features, means, or instructions for receiving, from the network entity, a second groupcast message, a second multicast message, or both, indicating an updated PTRS configuration based on the transmitted feedback.

In some examples of the method, apparatuses, and non-transitory computer-readable medium described herein, the PTRS configuration includes a PTRS data structure for the set of multiple UEs and the PTRS data structure may be different from a unicast PTRS data structure.

In some examples of the method, apparatuses, and non-transitory computer-readable medium described herein, the PTRS configuration may be preconfigured at the UE, a network entity, or both, based on a capability of the UE, the network entity, or both.

Some examples of the method, apparatuses, and non-transitory computer-readable medium described herein may further include operations, features, means, or instructions for determining the UE being part of multiple groups of UE groups for the data communication including the broadcast data communication, the multicast data communication, or the groupcast data communication, or any combination thereof and receiving a message indicating the PTRS configuration may be based on the UE being part of the multiple groups of UE groups.

In some examples of the method, apparatuses, and non-transitory computer-readable medium described herein, receiving the message indicating the PTRS configuration may include operations, features, means, or instructions for receiving a respective message indicating a respective PTRS configuration per group of multiple groups of UE groups, where receiving the data communication includes and receiving the groupcast data communication associated with a respective group of the multiple groups of UE groups based on the respective PTRS configuration of the respective group.

In some examples of the method, apparatuses, and non-transitory computer-readable medium described herein, each of one or more groups of the multiple groups of UE groups corresponds to a respective group common radio network temporary identifier (RNTI).

Some examples of the method, apparatuses, and non-transitory computer-readable medium described herein may further include operations, features, means, or instructions for receiving a downlink control information scheduling a respective data communication for a respective group of the multiple groups of UE groups, where receiving the groupcast data communication may be based on the received downlink control information.

In some examples of the method, apparatuses, and non-transitory computer-readable medium described herein, the respective group common RNTI corresponding to the respective group may be scrambled with a cyclic redundancy check bit associated with the downlink control information scheduling the respective data communication for the respective group of the multiple groups of UE groups.

In some examples of the method, apparatuses, and non-transitory computer-readable medium described herein, different data communications for each of the one or more groups of the multiple groups of UE groups corresponds to different group common RNTIs.

A method for wireless communication at a network entity is described. The method may include determining a PTRS configuration associated with data communication for a set of multiple UE, the data communication including a broadcast data communication, a multicast data communication, or a groupcast data communication, or any combination thereof, outputting a PTRS based on the determined PTRS configuration, and outputting the data communication based on the determined PTRS configuration.

An apparatus for wireless communication at a network entity is described. The apparatus may include a processor, and a memory coupled with the processor, with instructions stored in the memory, the instructions being executable by the processor to cause the apparatus to determine a PTRS configuration associated with data communication for a set of multiple UE, the data communication including a broadcast data communication, a multicast data communication, or a groupcast data communication, or any combination thereof, output a PTRS based on the determined PTRS configuration, and output the data communication based on the determined PTRS configuration.

Another apparatus for wireless communication at a network entity is described. The apparatus may include means for determining a PTRS configuration associated with data communication for a set of multiple UE, the data communication including a broadcast data communication, a multicast data communication, or a groupcast data communication, or any combination thereof, means for outputting a PTRS based on the determined PTRS configuration, and means for outputting the data communication based on the determined PTRS configuration.

A non-transitory computer-readable medium storing code for wireless communication at a network entity is described. The code may include instructions executable by a processor to determine a PTRS configuration associated with data communication for a set of multiple UE, the data communication including a broadcast data communication, a multicast data communication, or a groupcast data communication, or any combination thereof, output a PTRS based on the determined PTRS configuration, and output the data communication based on the determined PTRS configuration.

In some examples of the method, apparatuses, and non-transitory computer-readable medium described herein, outputting the PTRS may include operations, features, means, or instructions for broadcasting the PTRS based on the broadcast data communication.

In some examples of the method, apparatuses, and non-transitory computer-readable medium described herein, outputting the PTRS may include operations, features, means, or instructions for transmitting, to the set of multiple UEs, the PTRS based on the multicast data communication, the groupcast data communication, or both.

Some examples of the method, apparatuses, and non-transitory computer-readable medium described herein may further include operations, features, means, or instructions for broadcasting a first message indicating the PTRS configuration.

Some examples of the method, apparatuses, and non-transitory computer-readable medium described herein may further include operations, features, means, or instructions for transmitting, to a group of UEs of the set of multiple UEs, a first message indicating the PTRS configuration.

Some examples of the method, apparatuses, and non-transitory computer-readable medium described herein may further include operations, features, means, or instructions for determining a subscription of one or more UEs of the set of multiple UEs based on the multicast data communication, the groupcast data communication, or both, the subscription associated with the group of UEs, where outputting the PTRS configuration includes and transmitting, to the one or more UEs, a second message indicating the PTRS configuration based on an admittance to the subscription.

Some examples of the method, apparatuses, and non-transitory computer-readable medium described herein may further include operations, features, means, or instructions for receiving a capability report from one or more UEs of the set of multiple UEs, the capability report indicating a PTRS capability or a preferred PTRS configuration and where determining the PTRS configuration may be based on the capability report.

Some examples of the method, apparatuses, and non-transitory computer-readable medium described herein may further include operations, features, means, or instructions for receiving feedback associated with the PTRS configuration from one or more UEs of the group of UEs, where the feedback includes a decoding failure cause associated with the data communication and updating the PTRS configuration based on the received feedback.

Some examples of the method, apparatuses, and non-transitory computer-readable medium described herein may further include operations, features, means, or instructions for transmitting, to the group of UEs of the set of multiple UEs, a second groupcast message, a second multicast message, or both, indicating the updated PTRS configuration.

In some examples of the method, apparatuses, and non-transitory computer-readable medium described herein, the PTRS configuration includes a PTRS data structure for the set of multiple UEs and the PTRS structure may be different from a unicast PTRS data structure.

In some examples of the method, apparatuses, and non-transitory computer-readable medium described herein, the PTRS configuration may be preconfigured at one or more UEs of the set of multiple UEs, the network entity, or both, based on a capability of the one or more UEs, the network entity, or both.

### BRIEF DESCRIPTION OF THE DRAWINGS

FIG. 1 and FIG. 2 illustrate examples of wireless communications systems that support PTRS configuration for broadcast and multicast wireless communications in accordance with one or more aspects of the present disclosure.

FIG. 3 illustrates an example of a process flow that supports PTRS configuration for broadcast and multicast wireless communications in accordance with one or more aspects of the present disclosure.

FIGS. 4 and 5 show block diagrams of devices that support PTRS configuration for broadcast and multicast wireless communications in accordance with one or more aspects of the present disclosure.

FIG. 6 shows a block diagram of a communications manager that supports PTRS configuration for broadcast and multicast wireless communications in accordance with one or more aspects of the present disclosure.

FIG. 7 shows a diagram of a system including a device that supports PTRS configuration for broadcast and multicast wireless communications in accordance with one or more aspects of the present disclosure.

FIGS. 8 and 9 show block diagrams of devices that support PTRS configuration for broadcast and multicast wireless communications in accordance with one or more aspects of the present disclosure.

FIG. 10 shows a block diagram of a communications manager that supports PTRS configuration for broadcast and multicast wireless communications in accordance with one or more aspects of the present disclosure.

FIG. 11 shows a diagram of a system including a device that supports PTRS configuration for broadcast and multicast wireless communications in accordance with one or more aspects of the present disclosure.

FIGS. 12 through 14 show flowcharts illustrating methods that support PTRS configuration for broadcast and multicast wireless communications in accordance with one or more aspects of the present disclosure.

### DETAILED DESCRIPTION

In some wireless communications systems, a network entity may output one or more reference signals to assist a UE in receiving wireless communications. One such reference signal may be a PTRS that may be used by the UE to compensate for phase noise and other frequency impairments. Phase noise may increase as a function of oscillator carrier frequency, and PTRS may be utilized at higher carrier frequencies, such as millimeter wave (mmW) frequencies for example, to mitigate the phase noise and other frequency impairments. In some cases, the PTRS may be configured for data communications utilizing unicast signaling. However, some techniques might not support a procedure for data communications intended for multiple UEs, particularly broadcast data communication, multicast data communication, and groupcast data communication. Due to the lack of support for data communications intended for multiple UEs, the multiple UEs may not receive a PTRS configuration, be able to utilize a higher data rate, and may experience other drawbacks (e.g., lack of flexibility for group operations, inefficient use of resources, higher overhead, etc.).

The techniques described herein provide procedures for a PTRS configuration for broadcast and multicast communications. The techniques enable a wireless communication device (e.g., a network entity) to determine a PTRS configuration associated with a data communication for multiple UEs. For example, a network entity may determine that a data communication includes data intended for multiple UEs. The network entity, the multiple UEs, or both, may determine a PTRS configuration (e.g., a PTRS table separate from a unicast PTRS table) for the multiple UEs (e.g., based on a condition of the multiple UEs, a default configuration, etc.). The multiple UEs may receive a PTRS signal and the data communication based on the determined PTRS configuration. In some examples, the multiple UEs may be known to the network entity as a group of UEs and the network entity may determine the PTRS configuration based on a condition of the group of UEs, a condition of each UE of the group of UEs, or both. The network entity may transmit the PTRS configuration to the group of UEs.

Aspects of the disclosure are initially described in the context of wireless communications systems. Aspects of the disclosure are further illustrated by and described herein with reference to apparatus diagrams, system diagrams, and flowcharts that relate to PTRS configuration for broadcast and multicast wireless communications.

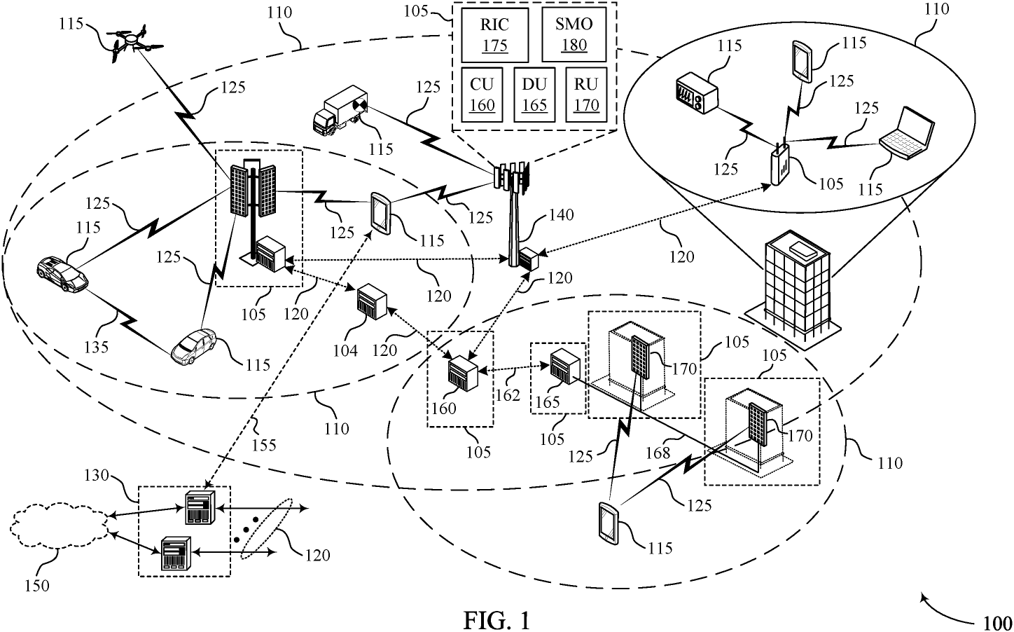

FIG. 1 illustrates an example of a wireless communications system 100 that supports PTRS configuration for broadcast and multicast wireless communications in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In some examples, network entities 105 and UEs 115 may wirelessly communicate via one or more communication links 125. For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an access point, a radio transceiver, a NodeB, an eNodeB (eNB), a next-generation NodeB or a giga-NodeB (either of which may be referred to as a gNB), a next-generation eNB (ng-eNB), a Home NodeB, a Home eNodeB, or other suitable terminology). A network entity 105 (e.g., a base station 140) may be implemented in an aggregated or monolithic base station architecture, or alternatively, in a disaggregated base station architecture. For example, a network entity 105 may include one or more of a central unit (CU) 160, a distributed unit (DU) 165, a radio unit (RU) 170, a Radio Access Network (RAN) Intelligent Controller (RIC) 175 (e.g., a Near-Real Time RIC (Near-RT RIC), a Non-Real Time RIC (Non-RT RIC), a Service Management and Orchestration (SMO) 180 system, or any combination thereof. An RU 170 may also be referred to as a radio head, a smart radio head, a remote radio head (RRH), a remote radio unit (RRU), or a transmission/reception point (TRP). One or more components of the network entities 105 of a disaggregated RAN may be co-located, or one or more components of the network entities 105 may be located in distributed locations.

The split of functionality between a CU 160, a DU 165, and an RU 175 is flexible and may support different functionalities depending upon which functions (e.g., network layer functions, protocol layer functions, baseband functions, radio frequency functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an integrated access backhaul (IAB) network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 (e.g., one or more RUs 170) may be partially controlled by CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support PTRS configuration for broadcast and multicast wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, subentity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the radio frequency spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to any combination of a radio frequency spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ = 1/(Δƒₘₐₓ ▪ Nƒ) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or any combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units (RSU), or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support mmW communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use any combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include any combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, a UE 115 may use a PTRS to compensate for phase noise and other frequency impairments. For example, at higher carrier frequencies, such as mmW frequencies for example, phase noise and other frequency impairments (e.g., carrier frequency offset (CFO) and doppler shift) may increase. Such frequency impairment may affect decoding performance in data transmissions (e.g., data transmissions with a medium or high modulation coding scheme (MCS)). To help mitigate the frequency impairment, UEs 115 may utilize PTRS signals as pilots to keep track of phase drift over time, and perform compensation techniques accordingly.

To determine time and frequency densities for the PTRS (e.g., for SU-MIMO), the UE 115 may be preconfigured, configured (e.g., RRC configured), or both, with one or more PTRS density tables associated with scheduled MCSs and bandwidths. For example, the UE 115 may be configured with a set of tables where a first table of the set may map MCS thresholds to PTRS time densities, and a second table of the set may map bandwidth allocation thresholds (e.g., a number of contiguous resource blocks or scheduled bandwidth) to PTRS frequency densities. In some examples (e.g., cyclic prefix-orthogonal division multiplexing (CP-OFDM)), the first table may include time densities for every fourth, second, and every symbol, depending on the MCS thresholds. In some cases, the UE 115 may expect, based on the second table, for the time densities to increase as the scheduled MCSs increase (time densities for some reserved MCSs may not increase with the MCSs). Additionally, the second table may include frequency densities occupying one subcarrier in every resource block, every second resource block, and every fourth resource block, depending on the contiguous scheduled bandwidth allocation values (e.g., a number of scheduled resource blocks). Depending on the time densities, the frequency densities may occupy a portion or all resource elements of the resource block. In some cases, the UE 115 may expect, based on the second table, for the frequency densities to decrease as the contiguous scheduled bandwidth allocation values increases. A UE 115 may thereby determine time and frequency densities for PTRSs based on the set of tables and a particular MCS value and bandwidth allocation value.

In some cases, the UE 115 may determine the time and frequency densities based on a pre-configuration. For example, the UE 115 may be preconfigured with PTRS parameters (e.g., DL-PTRS-present and UL-PTRS-present). When the PTRS parameters are enabled, the UE 115 may determine that a number of PTRS ports (e.g., one PTRS port) are present in every OFDM symbol and for every Nth resource block (e.g., every second resource block). In some cases, the configured PTRS tables (e.g., RRC configured tables) may take precedence over the preconfigured PTRS parameters.

PTRS signals may be improved for different scenarios to help the UE 115 reach a higher performance. As such, different PTRS densities (e.g., time and frequency densities) may be desired to compensate for phase noise and other frequency impairments. Because the PTRS density is a function of phase noise, the UE 115 may recommend a preferred PTRS density based on a phase noise property of the UE 115. In some cases, the UE 115 may send recommendations for the preferred PTRS density for each bandwidth, subcarrier spacing, and MCS, as a UE capability in an RRC message. For unicast scenarios, the PTRS tables may be RRC configured on a per UE basis based on a UE capability report.

Some techniques may support PTRS configuration for both UE dedicated physical data shared channel (PDSCH) and physical uplink shared channel (PUSCH) unicast scenarios. However, these techniques might not support a procedure for data communications intended for multiple UEs 115 at higher carrier frequencies (e.g., mmW), particularly broadcast data communication, multicast data communication, and groupcast data communication. For some use cases, the broadcast data communication (e.g., PDSCH transmissions at frequency range designation FR2) may include remaining minimum system information (RMSI) that uses a low MCS (e.g., quadrature phase-shift keying (QPSK)) such that phase drifting may minimally affect decoding performance and PTRS may not be configured. Some use cases for the broadcast data communication, the multicast data communication, and the groupcast data communication may include transmissions (e.g., transmissions at FR2) with a high data rate requirement, such that PTRS may help the UE 115 to decode the data communication with a higher MCS. These use cases may include, but not exclusively relate to, machine learning applications, sensor data sharing in cellular-vehicle to everything (CV2X) scenarios, and video broadcasting.

For machine learning applications, a network entity 105 may configure machine learning models, with many parameters, at multiple UEs 115 based on a location. In some examples, the machine learning model may help the UEs 115 predict future beams based on past beam measurements. The many parameters may depend on neural network predictors that are based on the location. For all or a portion of the multiple UEs 115 at the location, a same machine learning model may be shared. In order for the machine learning model to stay relevant, in many cases, the network entity 105 may update the many parameters over time. For example, the network entity 105 may update the many parameters through a data communication intended for all or a portion of the multiple UEs 115 at the location that are using the same machine learning model. The multiple UEs 115 may utilize a PTRS configuration to help decode the data communication.

For sensor data sharing in CV2X applications, a network entity 105 (e.g., a CV2X network entity or roadside unit (RSU)) may share sensor data to all connected UEs 115 (e.g., connected cars). In some examples, the sensor data may consist of light detection and ranging (LIDAR), video, or radar sensing data. The sensor data may include a large amount of data (e.g., video pixels) that may utilize a high MCS. To help decode the data communication utilizing the high MCS, the connected UEs 115 may utilize a PTRS configuration. While the techniques described herein may be directed toward use cases with data communication intended for multiple UEs 115 with a medium to high MCS, the techniques are not limited to these use cases and may be further applied to any use case associated with data communication intended for the multiple UEs 115.

Because the data communication is intended for the multiple UEs 115, the PTRS configuration may account for different phase noise properties. For example, some UEs 115 of the multiple UEs 115 may have different phase noise properties, such that different PTRS densities are desired to decode the same data communication. The different phase noise properties may be based on UE complexity, UE capability, or other factors affecting the phase noise. Some UEs 115 with low phase noise levels may decode the data communication without PTRS, while other UEs 115 may use the PTRS to first recover (compensate for) phase noise and then decode the data communication. To allow all of the multiple UEs 115 (e.g., target UEs 115) to decode the data communication, the PTRS configuration may be preconfigured, configured, or both, to consider all of the various phase noise properties of the multiple UEs 115, the worst phase noise property of the multiple UEs 115, some minimum requirement of the multiple UEs 115, among other conditions of the multiple UEs 115, or any combination thereof. In some cases, the PTRS configuration for the broadcast data communication, the multicast data communication, and the groupcast data communication may be separately configured (e.g., have separate tables) from the unicast PTRS configuration.

In some examples, the network entity 105, the multiple UEs 115, or both, may determine the PTRS configuration for the multiple UEs 115 (e.g., based on a condition of the multiple UEs 115, a default configuration, etc.). The multiple UEs 115 may receive a PTRS signal and a data communication intended for the multiple UEs 115 based on the determined PTRS configuration. In some examples, the multiple UEs 115 may be known to the network entity 105 as a group of UEs 115 and the network entity 105 may determine the PTRS configuration based on a condition of the group of UEs 115, a condition of each UE 115 of the group of UEs 115, or both. The network entity 105 may transmit the PTRS configuration to the group of UEs 115.

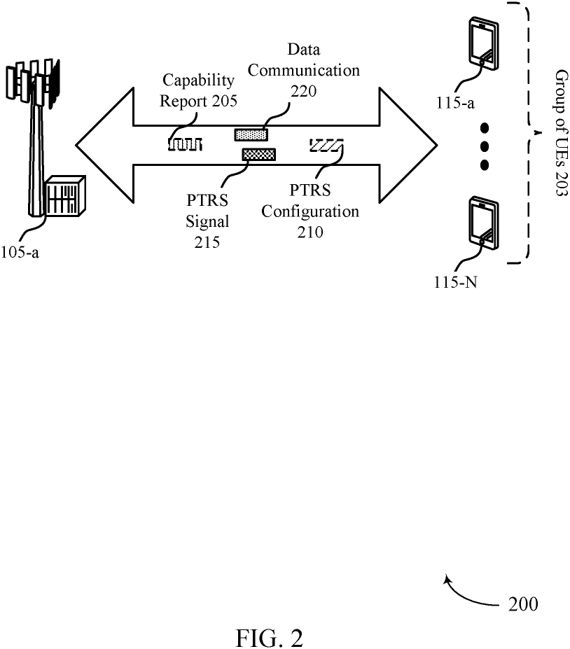

FIG. 2 illustrates an example of a wireless communications system 200 that supports PTRS configuration for broadcast and multicast wireless communications in accordance with one or more aspects of the present disclosure. In some examples, the wireless communications system 200 may implement aspects of the wireless communications system 100. The wireless communications system 200 may include multiple UEs 115 including a UE 115-a to a UE 115-N and a network entity 105-a, which may be examples of a UE 115 and a network entity 105 respectively, as described herein with reference to FIG. 1. The network entity 105-a may be in wireless communication with any, all, or none of the multiple UEs 115.

In some examples, the network entity 105-a may communicate with the multiple UEs 115-a through 115-N via a data communication, particularly a broadcast communication, a multicast communication, a groupcast communication, or any combination thereof. The wireless communications system 200 may implement procedures for the network entity 105-a and the multiple UEs 115 (e.g., the UE 115-a through the UE 115-N) to determine a PTRS configuration for the data communication. The network entity 105-a may determine to transmit a data communication 220 (e.g., the broadcast, the multicast, the groupcast communication, or any combination thereof) intended for the multiple UEs 115-a through 115-N, for example using mmW frequencies. However, phase noise and other frequency impairments may affect a decoding performance of the multiple UEs 115-a through 115-N for the data communication 220. To help mitigate the frequency impairments, the network entity may transmit a PTRS signal 215 along with the data communication 220, allowing the multiple UEs 115-a through 115-N to track phase drift over time and compensate for the phase noise and the other frequency impairments.

In some cases, the multiple UEs 115-a through 115-N may be known to the network entity 105-a as a group of UEs 203. For example, the network entity 105-a may form the group of UEs 203 based on a condition (e.g., location, UE capability, signal quality, etc.) and manage a subscription of each UE (e.g., the UE 115-a) of the group of UEs 203 over time. To utilize the PTRS signal 215, the network entity 105-a may determine a PTRS configuration 210 for the data communication 220 based on a condition of the group of UEs 203. The condition of the group of UEs 203 may be based on a UE capability, a location, or feedback from the group of UEs 203, among others. The group of UEs 203 may transmit a capability report 205 to the network entity 105-a indicating the UE capability or a recommendation of the group of UEs 203. In some cases, the recommendation may be based on a phase noise property of the group of UEs 203. The network entity 105-a may further base the PTRS configuration 210 on the capability report 205.

In some cases, the PTRS configuration 210 may be different data structures (e.g., RRC tables) from a unicast PTRS configuration data structure (e.g., unicast RRC tables). For example, the PTRS configuration 210 may include one or more PTRS density tables associated with scheduled MCSs and bandwidths similar to the unicast PTRS density tables. However, because the PTRS configuration 210 is intended for the group of UEs 203, the PTRS configuration 210 may be a different configuration from the unicast PTRS configuration.

In some examples, the network entity 105-a may transmit control signaling (e.g., RRC signaling) indicating the PTRS configuration 210 to the group of UEs 203. The PTRS configuration may be dedicated to the group of UEs 203 for the data communication 220 and the PTRS signal 215. In some cases, the network entity 105-a may change the subscription of the UE 115-a over time and update the PTRS configuration 210 accordingly. For example, the UE 115-a may leave the group of UEs 203 and remove a phase noise property or other condition from the group of UEs 203 (e.g., the UE 115-a had the worst capability of the group of UEs 203). The network entity 105-a may reevaluate the condition of the group of UEs 203 and determine to update the PTRS configuration. The network entity 105-a may then transmit the updated PTRS configuration to the group of UEs 203 via control signaling (e.g., a MAC-CE, a downlink control information (DCI), etc.). The group of UEs 203 may receive the PTRS signal 215 and the data communication 220 (e.g., the multicast data communications, the groupcast data communications, or both) based on the updated PTRS configuration.

In another example, the UE 115-a may join the group of UEs 203. Upon being admitted to the group of UEs 203, the UE 115-a may receive the control signaling indicating the PTRS configuration 210 from the network entity 105-a. In some cases, the UE 115-a may introduce a new phase noise property or other condition to the group of UEs 203 (e.g., the UE 115-a has the worst capability of the group of UEs 203). The network entity 105-a may reevaluate the condition of the group of UEs 203 and determine to update the PTRS configuration. The network entity 105-a may then transmit the updated PTRS configuration to the group of UEs 203 via control signaling (e.g., a MAC-CE, a DCI, etc.). The group of UEs 203 may receive the PTRS signal 215 and the data communication 220 based on the updated PTRS configuration.

In some cases, the network entity 105-a may update the PTRS configuration 210 based on feedback from the group of UEs 203. For example, the UE 115-a may have a difficulty decoding the data communication 220 due to a phase noise being different from a phase noise indicated previously (e.g., using original data). In some examples, the group of UEs 203 may use default parameters (a default PTRS configuration). The default parameters may be preconfigured for the group of UEs 203, the network entity 105-a, or both, and the group of UEs 203 may utilize the default parameters before a group dedicated PTRS is configured (e.g., the PTRS configuration 210).

In some cases, the network entity 105-a may configure the UE 115-a into multiple groups of UEs 203. For example, the UE 115-a may be a part of a first group, a second group, or any combination of groups of UEs 203. The UE 115-a may receive a respective PTRS configuration 210 per group of UEs 203 of which the UE 115-a has a subscription. The UE 115-a may receive a respective PTRS signal 215 and a respective data communication 220 based on the respective PTRS configuration 210 per group of UEs 203 of which the UE 115-a has a subscription.

In some examples, each group of the multiple groups of UEs 203 may have an associated group common radio network temporary identifier (RNTI). The RNTI may be a specific identifier, different for every group. In some cases, the network entity 105-a may use a respective RNTI to scramble a codepoint (e.g., a cyclic redundancy check (CRC) bit) of a respective control signaling (e.g., a MAC-CE, a DCI, etc.) that schedules the respective data communication 220. Although the examples used are with reference to the group of UEs 203 as a whole, it is understood that the group of UEs 203 constitute different UEs (e.g., the UE 115-a through the UE 115-N) and that the examples used may be based on each, a portion, or all of the different UEs of the group of UEs 203.

In some examples, the network entity 105-a may broadcast the PTRS signal 215 and the data communication 220 (e.g., the broadcast data communication). For example, the network entity 105-a may not know the multiple UEs 115-a through 115-N and so does not have target UEs, and the network entity 105-a may not require feedback (e.g., an ACK or NACK) from receivers of the broadcast PTRS signal 215 and data communication 220 (the multiple UEs 115-a through 115-N), among other examples.

For both examples (transmitting to the group of UEs 203 or broadcasting to the multiple UEs 115-a through 115-N), the PTRS configuration 210 may be preconfigured, configured, or both. For example, the PTRS configuration 210 may be preconfigured based on some minimum requirement of the UE 115-a. The pre-configuration may be defined for the UE 115-a in a standard. Additionally, or alternatively, the network entity 105-a may determine the PTRS configuration 210 and broadcast, transmit, or both, the PTRS configuration 210. For example, the network entity 105-a may broadcast the PTRS configuration 210 as part of control signaling (e.g., system information, scheduling information, etc.) to locate the broadcast data communication 220. Based on receiving the broadcast PTRS configuration 210, the multiple UEs 115-a through 115-N may receive the broadcasted PTRS signal 215 and the broadcasted data communication 220.

In some cases, a different RNTI may be used for each configured PTRS configuration 210. For example, a cell RNTI (C_RNTI) may be used for unicast PTRS configurations 210, a group RNTI for each group of UEs 203 for a groupcast PTRS configuration 210, and a broadcast RNTI for a broadcast PTRS configuration 210 (e.g., for broadcast PDSCH). In some examples, the UE 115-a may use different PTRS configurations for the scheduled data communication 220 (e.g., for a scheduled PDSCH) based on the different RNTI that the UE 115-a decodes from the control signaling (e.g., the scheduling DCI).

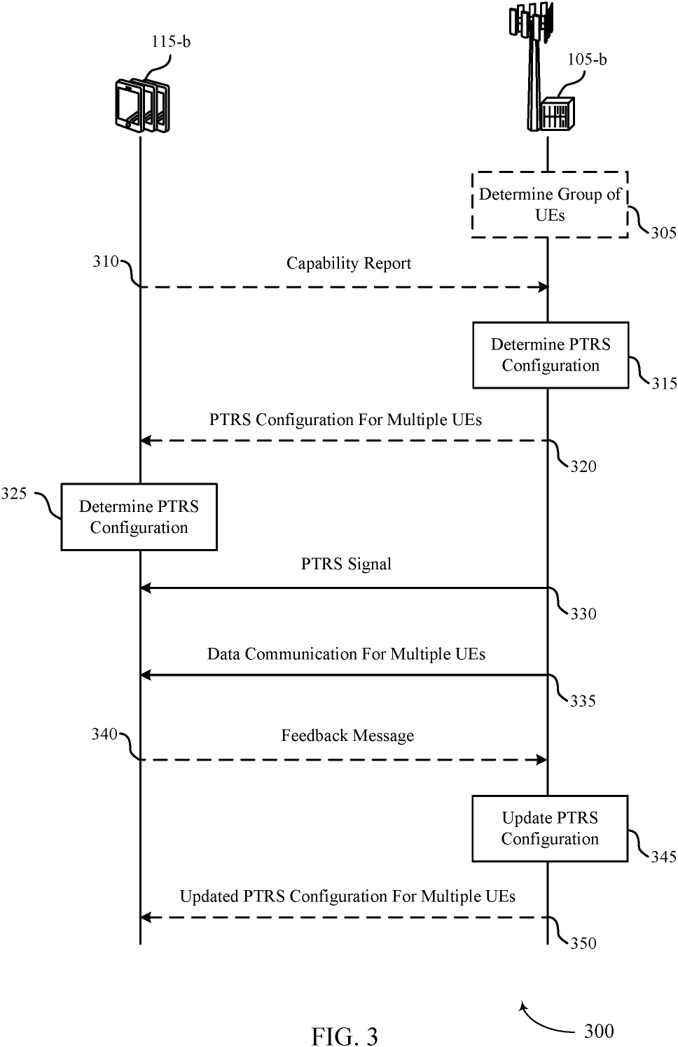

FIG. 3 illustrates an example of a process flow 300 that supports PTRS configuration for broadcast and multicast wireless communications in accordance with one or more aspects of the present disclosure. In some examples, the process flow 300 may implement or be implemented by aspects of the wireless communications systems 100 and 200 as described with reference to FIGS. 1 and 2, respectively. For example, the process flow 300 may be related to operations performed by multiple UEs 115-b and a network entity 105-b, which may be respective examples of UEs 115 and network entities 105 as described herein with reference to FIGS. 1 and 2. The network entity 105-b may determine to output a data communication, particularly a broadcast communication, a multicast communication, a groupcast communication, or any combination thereof, intended for the multiple UEs 115-b.

At 305, the network entity 105-b may optionally determine a group of UEs 115 of the multiple UEs 115-b. The network entity 105-b may form the group of UEs 115 based on a condition (e.g., location, UE capability, signal quality, etc.) and manage a subscription of each UE 115 of the group of UEs 115 over time. The subscription of each UE 115 may be based on the data communication intended for the group of UEs 115. For example, the network entity 105-b may admit or remove certain UEs 115 from the group of UEs 115 based on whether the data communication is intended for the certain UEs 115. It is understood that the procedures supported by the process flow 300 may relate to the multiple UEs 115-b, the group of UEs 115, each UE of the multiple UEs 115-b, a portion of the multiple UEs 115-b, or any combination thereof.

At 310, the multiple UEs 115-b may optionally transmit a capability report to the network entity 105-b. The capability report may include a capability (e.g., a PTRS capability) of the multiple UEs 115-b, a recommendation (e.g., a preferred PTRS configuration) of the multiple UEs 115-b, or both. For example, the capability of the multiple UEs 115-b, the recommendation of the multiple UEs 115-b, or both, may depend on a phase noise property of the multiple UEs 115-b.

At 315, the network entity 105-b may determine a PTRS configuration associated with the data communication for the multiple UEs 115-b. The PTRS configuration may be preconfigured (e.g., at the network entity 105-b, the multiple UEs 115-b, or both), configured, or both. In some cases, the PTRS configuration may be a default configuration associated with a minimum capability of the multiple UEs 115-b, the network entity 105-b, or both. In some cases, the PTRS configuration may depend on a condition of the multiple UEs 115-b, the capability report, a subscription of the multiple UEs 115-b, feedback from the multiple UEs 115-b, or any combination thereof.

At 320, the network entity 105-b may optionally output a first message indicating the PTRS configuration for the multiple UEs 115-b. In some cases, the network entity 105-b may broadcast the PTRS configuration, transmit the PTRS configuration to the multiple UEs 115-b, or both, based on the data communication intended for the multiple UEs 115-b.

At 325, the multiple UEs 115-b may determine the PTRS configuration. In some cases, the PTRS configuration may be a default (e.g., preconfigured) PTRS configuration. In some cases, the multiple UEs 115-b may determine the PTRS configuration associated with the data communication based on the network entity 105-b transmitting or broadcasting the PTRS configuration. In some examples, the PTRS configuration may include a PTRS data structure that is different (e.g., similar) from a unicast PTRS data structure, as described herein with reference to FIG. 2.

At 330, the network entity 105-b may output a PTRS signal. In some cases, the network entity 105-b may broadcast the PTRS signal associated with the broadcast data communication. In some cases, the network entity 105-b may transmit, to the group of UEs 115, the PTRS signal associated with the multicast data communication, the groupcast data communication, or both.

At 335, the network entity 105-b may output the data communications intended for the multiple UEs 115-b. In some cases, the network entity 105-b may broadcast the data communications, transmit the data communications, or both. The multiple UEs 115-b may utilize the PTRS signal to decode the data communication. For example, the multiple UEs 115-b may use the PTRS signal to compensate for phase noise and other frequency impairments associated with higher carrier frequencies (e.g., mmW frequencies) by keeping track of phase drift over time.

At 340, the multiple UEs 115-b may optionally transmit a feedback message associated with the PTRS configuration. In some cases, the feedback message may indicate a decoding failure cause associated with the data communication or a recommended PTRS configuration based on a phase noise property. For example, the multiple UEs 115-b may fail to decode the data communication based on the network entity 105-b assuming a wrong phase noise property or an outdated phase noise property, among other examples.

At 345, the network entity 105-b may optionally update the PTRS configuration. In some examples, the network entity 105-b may update the PTRS configuration based on the feedback message received from the multiple UEs 115-b. In some examples, the network entity 105-b may update the PTRS configuration over time based on an updated subscription status. For example, the network entity 105-b may reevaluate a condition of the multiple UEs 115-b based on a UE 115 joining or leaving the group of UEs 115. Based on the reevaluated condition, the network entity 105-b may determine that an update to the PTRS configuration is beneficial. At 350, the network entity 105-b may optionally output a second message indicating the updated PTRS configuration for the multiple UEs.

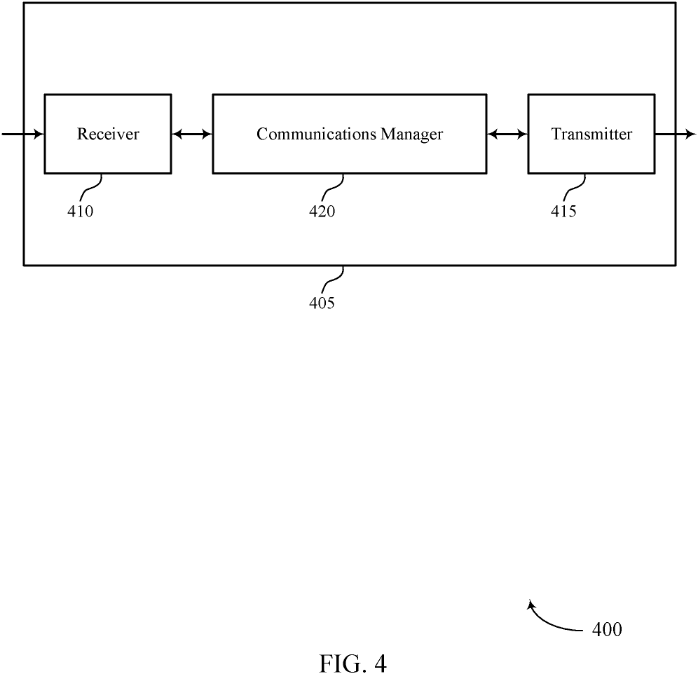

FIG. 4 shows a block diagram 400 of a device 405 that supports PTRS configuration for broadcast and multicast wireless communications in accordance with one or more aspects of the present disclosure. The device 405 may be an example of aspects of a UE 115 as described herein. The device 405 may include a receiver 410, a transmitter 415, and a communications manager 420. The device 405 may also include a processor (not shown). Each of these components may be in communication with one another (e.g., via one or more buses).

The receiver 410 may provide a means for receiving information such as packets, user data, control information, or any combination thereof associated with various information channels (e.g., control channels, data channels, information channels related to PTRS configuration for broadcast and multicast wireless communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to PTRS configuration for broadcast and multicast wireless communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of PTRS configuration for broadcast and multicast wireless communications as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE (e.g., the device 405) in accordance with examples as disclosed herein. For example, the communications manager 420 may be configured as or otherwise support a means for determining a PTRS configuration associated with data communication for a set of multiple UEs, the data communication including a broadcast data communication, a multicast data communication, a groupcast data communication, or any combination thereof. The communications manager 420 may be configured as or otherwise support a means for receiving a PTRS based on the determined PTRS configuration. The communications manager 420 may be configured as or otherwise support a means for receiving the data communication based on the determined PTRS configuration.

By including or configuring the communications manager 420 in accordance with examples as described herein, the device 405 (e.g., a processor controlling or otherwise coupled with the receiver 410, the transmitter 415, the communications manager 420, or any combination thereof) may support techniques for more efficient utilization of communication resources.

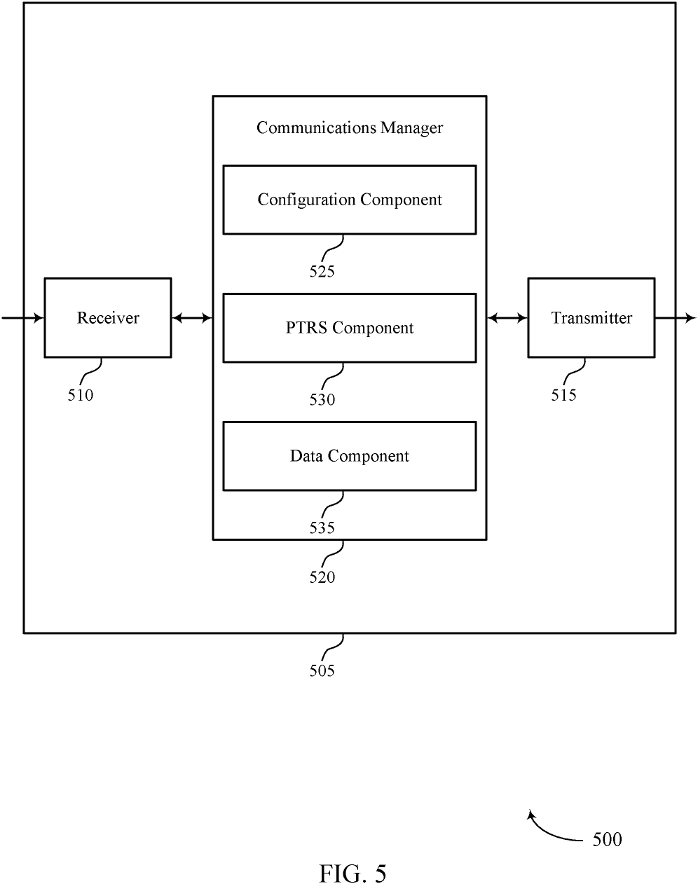

FIG. 5 shows a block diagram 500 of a device 505 that supports PTRS configuration for broadcast and multicast wireless communications in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor (not shown). Each of these components may be in communication with one another (e.g., via one or more buses).

The receiver 510 may provide a means for receiving information such as packets, user data, control information, or any combination thereof associated with various information channels (e.g., control channels, data channels, information channels related to PTRS configuration for broadcast and multicast wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to PTRS configuration for broadcast and multicast wireless communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of PTRS configuration for broadcast and multicast wireless communications as described herein. For example, the communications manager 520 may include a configuration component 525, an PTRS component 530, a data component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE (e.g., the device 505) in accordance with examples as disclosed herein. The configuration component 525 may be configured as or otherwise support a means for determining a PTRS configuration associated with data communication for a set of multiple UEs, the data communication including a broadcast data communication, a multicast data communication, a groupcast data communication, or any combination thereof. The PTRS component 530 may be configured as or otherwise support a means for receiving a PTRS based on the determined PTRS configuration. The data component 535 may be configured as or otherwise support a means for receiving the data communication based on the determined PTRS configuration.

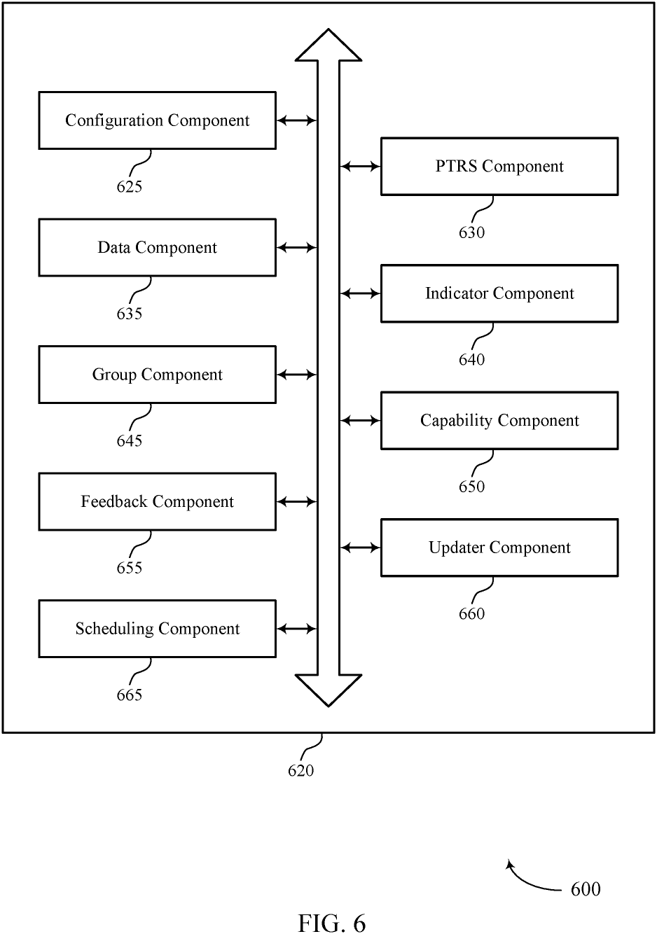

FIG. 6 shows a block diagram 600 of a communications manager 620 that supports PTRS configuration for broadcast and multicast wireless communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of PTRS configuration for broadcast and multicast wireless communications as described herein. For example, the communications manager 620 may include a configuration component 625, an PTRS component 630, a data component 635, an indicator component 640, a group component 645, a capability component 650, a feedback component 655, an updater component 660, a scheduling component 665, or any combination thereof. Each of these components may communicate, directly or indirectly, with one another (e.g., via one or more buses).

The communications manager 620 may support wireless communication at a UE in accordance with examples as disclosed herein. The configuration component 625 may be configured as or otherwise support a means for determining a PTRS configuration associated with data communication for a set of multiple UEs, the data communication including a broadcast data communication, a multicast data communication, a groupcast data communication, or any combination thereof. The PTRS component 630 may be configured as or otherwise support a means for receiving a PTRS based on the determined PTRS configuration. The data component 635 may be configured as or otherwise support a means for receiving the data communication based on the determined PTRS configuration.

In some examples, to support receiving the PTRS, the PTRS component 630 may be configured as or otherwise support a means for receiving, from a network entity, a broadcast message including the PTRS based on the broadcast data communication. In some examples, to support receiving the PTRS, the PTRS component 630 may be configured as or otherwise support a means for receiving, from a network entity, a multicast message, a groupcast message, or both, including the PTRS based on the multicast data communication, the groupcast data communication, or both.

In some examples, the indicator component 640 may be configured as or otherwise support a means for receiving, from a network entity, a broadcast message indicating the PTRS configuration. In some examples, the indicator component 640 may be configured as or otherwise support a means for receiving, from a network entity, a first multicast message, a first groupcast message, or both, indicating the PTRS configuration for a group of UEs of the set of multiple UEs, the group of UEs including at least a subset of the set of multiple UEs. In some examples, receiving the PTRS configuration is based on an admittance to a subscription of the group of UEs.

In some examples, the capability component 650 may be configured as or otherwise support a means for transmitting a capability report indicating a PTRS capability or a preferred PTRS configuration. In some examples, the configuration component 625 may be configured as or otherwise support a means for determining the PTRS configuration based on the capability report. In some examples, the feedback component 655 may be configured as or otherwise support a means for transmitting, to the network entity, feedback associated with the PTRS configuration, where the feedback includes a decoding failure cause associated with the data communication.

In some examples, the updater component 660 may be configured as or otherwise support a means for receiving, from the network entity, a second groupcast message, a second multicast message, or both, indicating an updated PTRS configuration based on the transmitted feedback. In some examples, the PTRS configuration includes a PTRS data structure for the set of multiple UEs. In some examples, the PTRS data structure is different from a unicast PTRS data structure. In some examples, the PTRS configuration is preconfigured at the UE, a network entity, or both, based on a capability of the UE, the network entity, or both.

In some examples, the group component 645 may be configured as or otherwise support a means for determining the UE being part of multiple groups of UE groups for the data communication including the broadcast data communication, the multicast data communication, or the groupcast data communication, or any combination thereof. In some examples, the configuration component 625 may be configured as or otherwise support a means for receiving a message indicating the PTRS configuration is based on the UE being part of the multiple groups of UE groups. In some examples, to support receiving the message indicating the PTRS configuration, the indicator component 640 may be configured as or otherwise support a means for receiving a respective message indicating a respective PTRS configuration per group of multiple groups of UE groups. In some examples, to support receiving the message indicating the PTRS configuration, the data component 635 may be configured as or otherwise support a means for receiving the groupcast data communication associated with a respective group of the multiple groups of UE groups based on the respective PTRS configuration of the respective group.

In some examples, each of one or more groups of the multiple groups of UE groups corresponds to a respective group common RNTI. In some examples, the scheduling component 665 may be configured as or otherwise support a means for receiving a downlink control information scheduling a respective data communication for a respective group of the multiple groups of UE groups, where receiving the groupcast data communication is based on the received downlink control information. In some examples, the respective group common RNTI corresponding to the respective group is scrambled with a cyclic redundancy check bit associated with the downlink control information scheduling the respective data communication for the respective group of the multiple groups of UE groups. In some examples, different data communications for each of the one or more groups of the multiple groups of UE groups corresponds to different group common RNTIs.

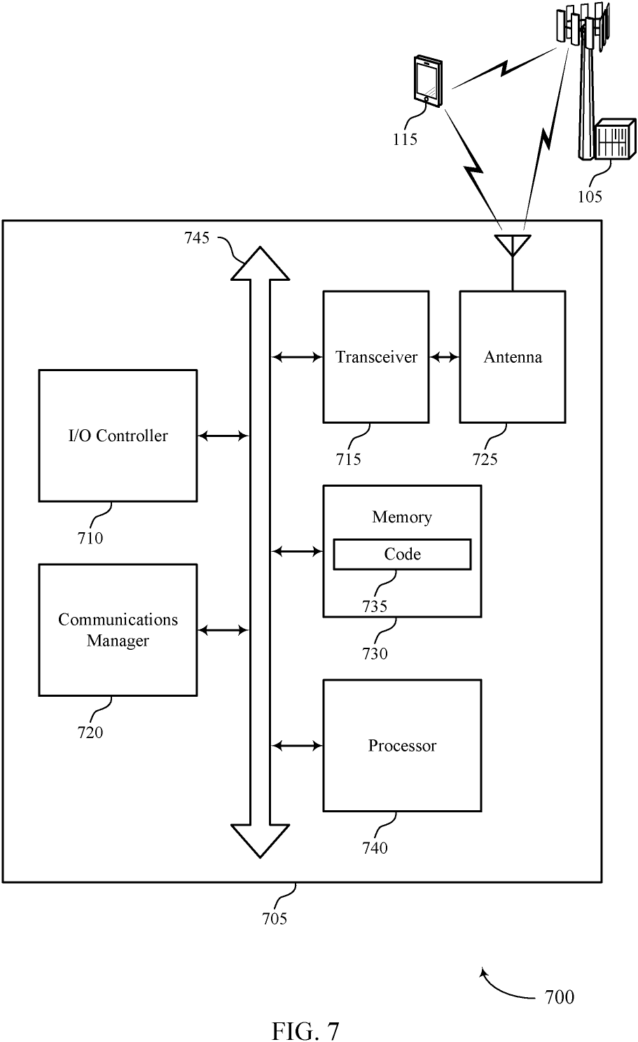

FIG. 7 shows a diagram of a system 700 including a device 705 that supports PTRS configuration for broadcast and multicast wireless communications in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting PTRS configuration for broadcast and multicast wireless communications). For example, the device 705 or a component of the device 705 may include a processor 740 and memory 730 coupled with or to the processor 740, the processor 740 and memory 730 configured to perform various functions described herein.

The communications manager 720 may support wireless communication at a UE (e.g., the device 705) in accordance with examples as disclosed herein. For example, the communications manager 720 may be configured as or otherwise support a means for determining a PTRS configuration associated with data communication for a set of multiple UEs, the data communication including a broadcast data communication, a multicast data communication, a groupcast data communication, or any combination thereof. The communications manager 720 may be configured as or otherwise support a means for receiving a PTRS based on the determined PTRS configuration. The communications manager 720 may be configured as or otherwise support a means for receiving the data communication based on the determined PTRS configuration.

By including or configuring the communications manager 720 in accordance with examples as described herein, the device 705 may support techniques for more efficient utilization of communication resources, improved coordination between devices, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described herein with reference to the communications manager 720 may be supported by or performed by the processor 740, the memory 730, the code 735, or any combination thereof. For example, the code 735 may include instructions executable by the processor 740 to cause the device 705 to perform various aspects of PTRS configuration for broadcast and multicast wireless communications as described herein, or the processor 740 and the memory 730 may be otherwise configured to perform or support such operations.

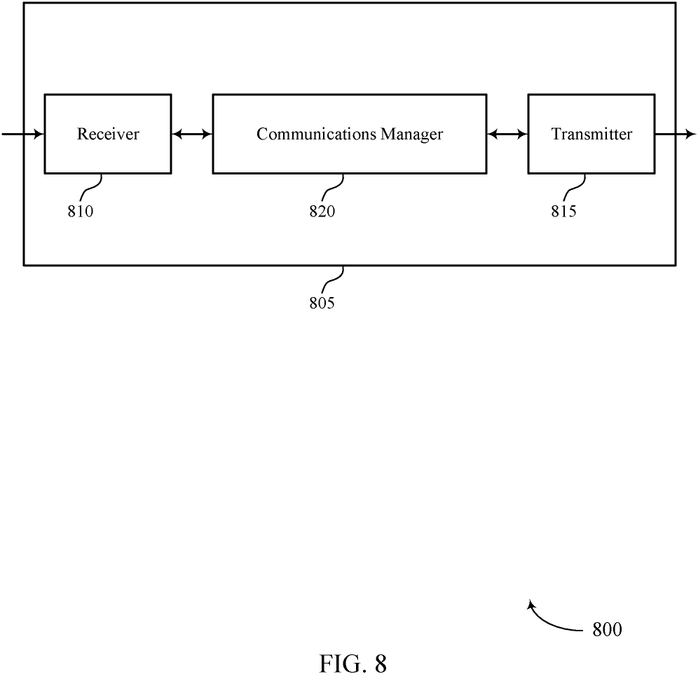

FIG. 8 shows a block diagram 800 of a device 805 that supports PTRS configuration for broadcast and multicast wireless communications in accordance with one or more aspects of the present disclosure. The device 805 may be an example of aspects of a network entity 105 as described herein. The device 805 may include a receiver 810, a transmitter 815, and a communications manager 820. The device 805 may also include a processor (not shown). Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of PTRS configuration for broadcast and multicast wireless communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity (e.g., the device 805) in accordance with examples as disclosed herein. For example, the communications manager 820 may be configured as or otherwise support a means for determining a PTRS configuration associated with data communication for a set of multiple UE, the data communication including a broadcast data communication, a multicast data communication, or a groupcast data communication, or any combination thereof. The communications manager 820 may be configured as or otherwise support a means for outputting a PTRS based on the determined PTRS configuration. The communications manager 820 may be configured as or otherwise support a means for outputting the data communication based on the determined PTRS configuration.

By including or configuring the communications manager 820 in accordance with examples as described herein, the device 805 (e.g., a processor controlling or otherwise coupled with the receiver 810, the transmitter 815, the communications manager 820, or any combination thereof) may support techniques for more efficient utilization of communication resources.

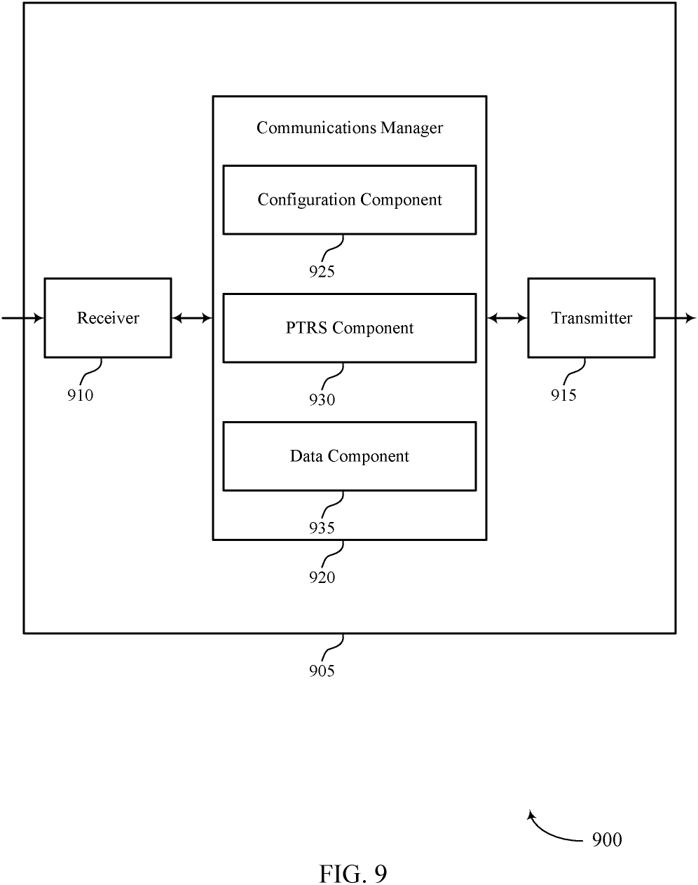

FIG. 9 shows a block diagram 900 of a device 905 that supports PTRS configuration for broadcast and multicast wireless communications in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor (not shown). Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of PTRS configuration for broadcast and multicast wireless communications as described herein. For example, the communications manager 920 may include a configuration component 925, an PTRS component 930, a data component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity (e.g., the device 905) in accordance with examples as disclosed herein. The configuration component 925 may be configured as or otherwise support a means for determining a PTRS configuration associated with data communication for a set of multiple UE, the data communication including a broadcast data communication, a multicast data communication, or a groupcast data communication, or any combination thereof. The PTRS component 930 may be configured as or otherwise support a means for outputting a PTRS based on the determined PTRS configuration. The data component 935 may be configured as or otherwise support a means for outputting the data communication based on the determined PTRS configuration.

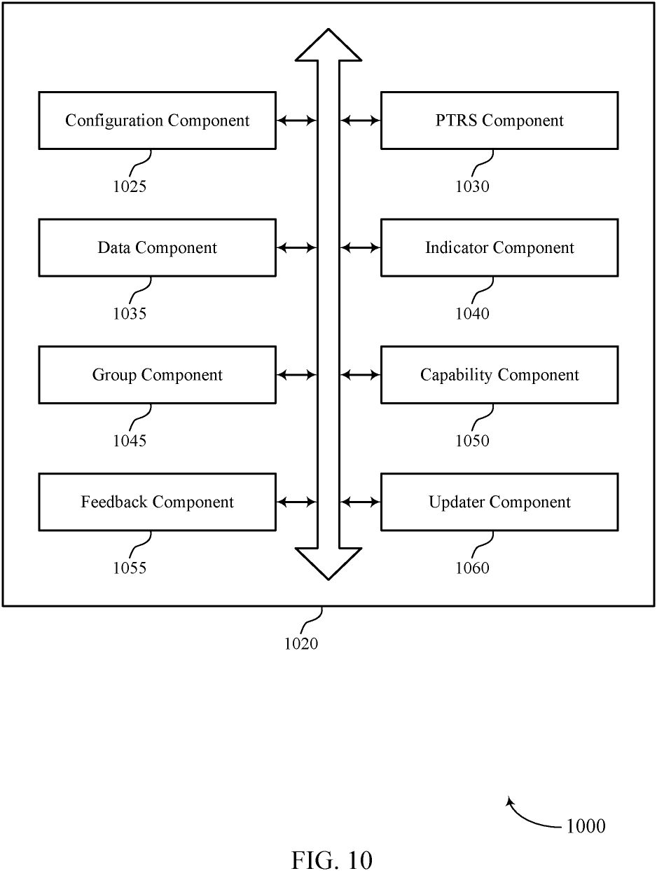

FIG. 10 shows a block diagram 1000 of a communications manager 1020 that supports PTRS configuration for broadcast and multicast wireless communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of PTRS configuration for broadcast and multicast wireless communications as described herein. For example, the communications manager 1020 may include a configuration component 1025, an PTRS component 1030, a data component 1035, an indicator component 1040, a group component 1045, a capability component 1050, a feedback component 1055, an updater component 1060, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The configuration component 1025 may be configured as or otherwise support a means for determining a PTRS configuration associated with data communication for a set of multiple UE, the data communication including a broadcast data communication, a multicast data communication, or a groupcast data communication, or any combination thereof. The PTRS component 1030 may be configured as or otherwise support a means for outputting a PTRS based on the determined PTRS configuration. The data component 1035 may be configured as or otherwise support a means for outputting the data communication based on the determined PTRS configuration.

In some examples, to support outputting the PTRS, the PTRS component 1030 may be configured as or otherwise support a means for broadcasting the PTRS based on the broadcast data communication. In some examples, to support outputting the PTRS, the PTRS component 1030 may be configured as or otherwise support a means for transmitting, to the set of multiple UEs, the PTRS based on the multicast data communication, the groupcast data communication, or both. In some examples, the indicator component 1040 may be configured as or otherwise support a means for broadcasting a first message indicating the PTRS configuration.

In some examples, the indicator component 1040 may be configured as or otherwise support a means for transmitting, to a group of UEs of the set of multiple UEs, a first message indicating the PTRS configuration. In some examples, the group component 1045 may be configured as or otherwise support a means for determining a subscription of one or more UEs of the set of multiple UEs based on the multicast data communication, the groupcast data communication, or both, the subscription associated with the group of UEs. In some examples, the indicator component 1040 may be configured as or otherwise support a means for transmitting, to the one or more UEs, a second message indicating the PTRS configuration based on an admittance to the subscription.

In some examples, the capability component 1050 may be configured as or otherwise support a means for receiving a capability report from one or more UEs of the set of multiple UEs, the capability report indicating a PTRS capability or a preferred PTRS configuration. In some examples, the configuration component 1025 may be configured as or otherwise support a means for determining the PTRS configuration based on the capability report. In some examples, the feedback component 1055 may be configured as or otherwise support a means for receiving feedback associated with the PTRS configuration from one or more UEs of the group of UEs, where the feedback includes a decoding failure cause associated with the data communication. In some examples, the updater component 1060 may be configured as or otherwise support a means for updating the PTRS configuration based on the received feedback.

In some examples, the indicator component 1040 may be configured as or otherwise support a means for transmitting, to the group of UEs of the set of multiple UEs, a second groupcast message, a second multicast message, or both, indicating the updated PTRS configuration. In some examples, the PTRS configuration includes a PTRS data structure for the set of multiple UEs. In some examples, the PTRS structure is different from a unicast PTRS data structure. In some examples, the PTRS configuration is preconfigured at one or more UEs of the set of multiple UEs, the network entity, or both, based on a capability of the one or more UEs, the network entity, or both.

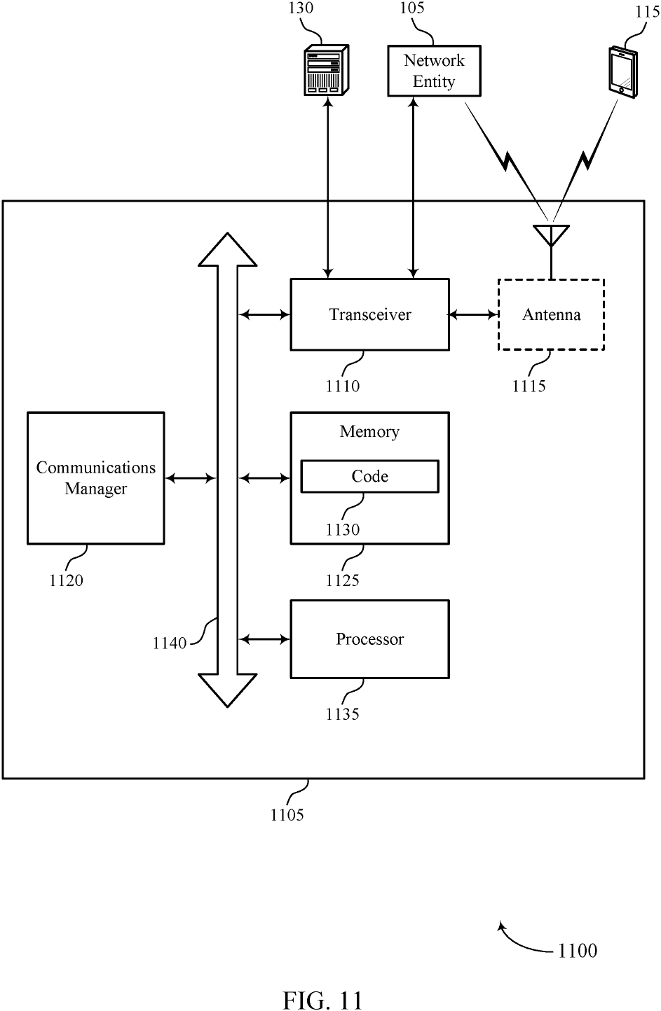

FIG. 11 shows a diagram of a system 1100 including a device 1105 that supports PTRS configuration for broadcast and multicast wireless communications in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting PTRS configuration for broadcast and multicast wireless communications). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity (e.g., the device 1105) in accordance with examples as disclosed herein. For example, the communications manager 1120 may be configured as or otherwise support a means for determining a PTRS configuration associated with data communication for a set of multiple UE, the data communication including a broadcast data communication, a multicast data communication, or a groupcast data communication, or any combination thereof. The communications manager 1120 may be configured as or otherwise support a means for outputting a PTRS based on the determined PTRS configuration. The communications manager 1120 may be configured as or otherwise support a means for outputting the data communication based on the determined PTRS configuration.

By including or configuring the communications manager 1120 in accordance with examples as described herein, the device 1105 may support techniques for more efficient utilization of communication resources, improved coordination between devices, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described herein with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of PTRS configuration for broadcast and multicast wireless communications as described herein, or the processor 1135 and the memory 1125 may be otherwise configured to perform or support such operations.

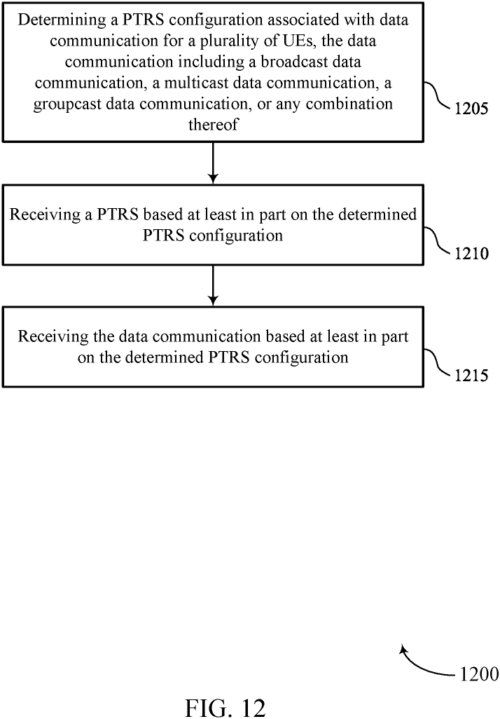

FIG. 12 shows a flowchart illustrating a method 1200 that supports PTRS configuration for broadcast and multicast wireless communications in accordance with one or more aspects of the present disclosure. The operations of the method 1200 may be implemented by a UE or its components as described herein. For example, the operations of the method 1200 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include determining a PTRS configuration associated with data communication for a set of multiple UEs, the data communication including a broadcast data communication, a multicast data communication, a groupcast data communication, or any combination thereof. The operations of 1205 may be performed in accordance with examples as disclosed herein. In some examples, aspects of the operations of 1205 may be performed by a configuration component 625 as described herein with reference to FIG. 6.

At 1210, the method may include receiving a PTRS based on the determined PTRS configuration. The operations of 1210 may be performed in accordance with examples as disclosed herein. In some examples, aspects of the operations of 1210 may be performed by an PTRS component 630 as described herein with reference to FIG. 6.

At 1215, the method may include receiving the data communication based at least in part on the determined PTRS configuration. The operations of 1215 may be performed in accordance with examples as disclosed herein. In some examples, aspects of the operations of 1215 may be performed by a data component 635 as described herein with reference to FIG. 6.

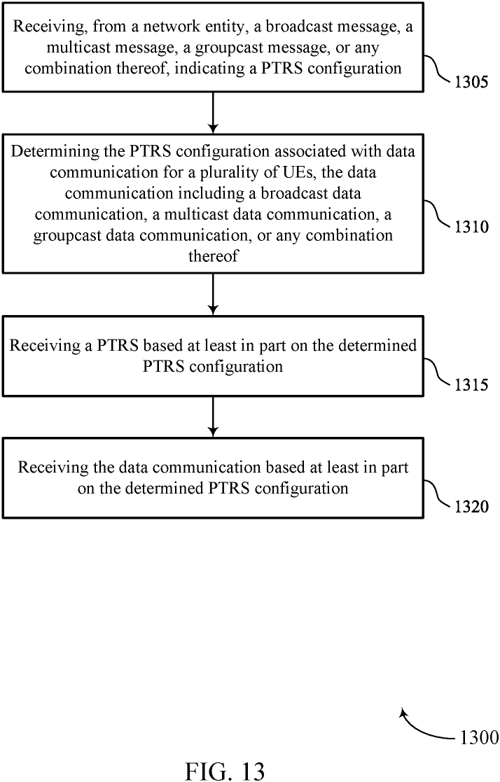

FIG. 13 shows a flowchart illustrating a method 1300 that supports PTRS configuration for broadcast and multicast wireless communications in accordance with one or more aspects of the present disclosure. The operations of the method 1300 may be implemented by a UE or its components as described herein. For example, the operations of the method 1300 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a broadcast message, a multicast message, a groupcast message, or any combination thereof, indicating a PTRS configuration. The operations of 1305 may be performed in accordance with examples as disclosed herein. In some examples, aspects of the operations of 1305 may be performed by an indicator component 640 as described herein with reference to FIG. 6.

At 1310, the method may include determining a PTRS configuration associated with data communication for a set of multiple UEs, the data communication including a broadcast data communication, a multicast data communication, a groupcast data communication, or any combination thereof. The operations of 1310 may be performed in accordance with examples as disclosed herein. In some examples, aspects of the operations of 1310 may be performed by a configuration component 625 as described herein with reference to FIG. 6.

At 1315, the method may include receiving a PTRS based at least in part on the determined PTRS configuration. The operations of 1315 may be performed in accordance with examples as disclosed herein. In some examples, aspects of the operations of 1315 may be performed by an PTRS component 630 as described herein with reference to FIG. 6.

At 1320, the method may include receiving the data communication based at least in part on the determined PTRS configuration. The operations of 1320 may be performed in accordance with examples as disclosed herein. In some examples, aspects of the operations of 1320 may be performed by a data component 635 as described herein with reference to FIG. 6.

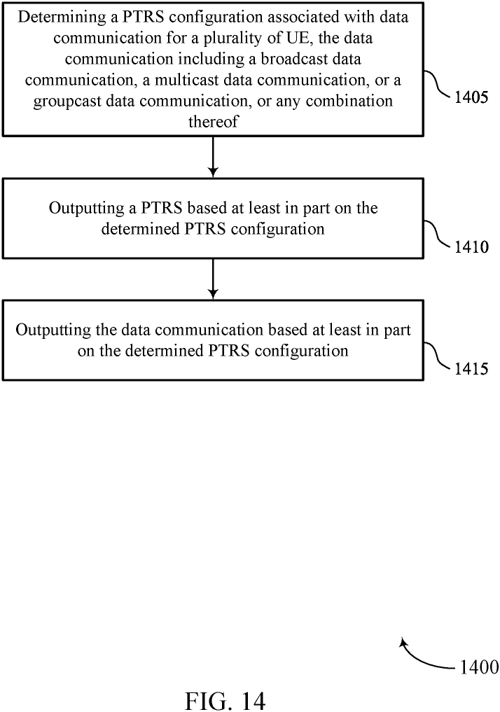

FIG. 14 shows a flowchart illustrating a method 1400 that supports PTRS configuration for broadcast and multicast wireless communications in accordance with one or more aspects of the present disclosure. The operations of the method 1400 may be implemented by a network entity or its components as described herein. For example, the operations of the method 1400 may be performed by a network entity as described herein with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include determining a PTRS configuration associated with data communication for a set of multiple UE, the data communication including a broadcast data communication, a multicast data communication, or a groupcast data communication, or any combination thereof. The operations of 1405 may be performed in accordance with examples as disclosed herein. In some examples, aspects of the operations of 1405 may be performed by a configuration component 1025 as described herein with reference to FIG. 10.

At 1410, the method may include outputting a PTRS based at least in part on the determined PTRS configuration. The operations of 1410 may be performed in accordance with examples as disclosed herein. In some examples, aspects of the operations of 1410 may be performed by an PTRS component 1030 as described herein with reference to FIG. 10.

At 1415, the method may include outputting the data communication based at least in part on the determined PTRS configuration. The operations of 1415 may be performed in accordance with examples as disclosed herein. In some examples, aspects of the operations of 1415 may be performed by a data component 1035 as described herein with reference to FIG. 10.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communication at a UE, comprising: determining a PTRS configuration associated with data communication for a plurality of UEs, the data communication comprising a broadcast data communication, a multicast data communication, a groupcast data communication, or any combination thereof; receiving a PTRS based at least in part on the determined PTRS configuration; and receiving the data communication based at least in part on the determined PTRS configuration.

Aspect 2: The method of aspect 1, wherein receiving the PTRS comprises: receiving, from a network entity, a broadcast message comprising the PTRS based at least in part on the broadcast data communication.

Aspect 3: The method of any of aspects 1 through 2, wherein receiving the PTRS comprises: receiving, from a network entity, a multicast message, a groupcast message, or both, comprising the PTRS based at least in part on the multicast data communication, the groupcast data communication, or both.

Aspect 4: The method of any of aspects 1 through 3, further comprising: receiving, from a network entity, a broadcast message indicating the PTRS configuration.

Aspect 5: The method of any of aspects 1 through 4, further comprising: receiving, from a network entity, a first multicast message, a first groupcast message, or both, indicating the PTRS configuration for a group of UEs of the plurality of UEs, the group of UEs comprising at least a subset of the plurality of UEs.

Aspect 6: The method of aspect 5, wherein receiving the PTRS configuration is based at least in part on an admittance to a subscription of the group of UEs.

Aspect 7: The method of any of aspects 5 through 6, further comprising: transmitting a capability report indicating a PTRS capability or a preferred PTRS configuration, wherein determining the PTRS configuration is based at least in part on the capability report.

Aspect 8: The method of any of aspects 5 through 7, further comprising: transmitting, to the network entity, feedback associated with the PTRS configuration, wherein the feedback comprises a decoding failure cause associated with the data communication.

Aspect 9: The method of aspect 8, further comprising: receiving, from the network entity, a second groupcast message, a second multicast message, or both, indicating an updated PTRS configuration based at least in part on the transmitted feedback.

Aspect 10: The method of any of aspects 1 through 9, wherein the PTRS configuration comprises a PTRS data structure for the plurality of UEs, and the PTRS data structure is different from a unicast PTRS data structure.

Aspect 11: The method of any of aspects 1 through 10, wherein the PTRS configuration is preconfigured at the UE, a network entity, or both, based at least in part on a capability of the UE, the network entity, or both.

Aspect 12: The method of any of aspects 1 through 11, further comprising: determining the UE being part of multiple groups of UE groups for the data communication comprising the broadcast data communication, the multicast data communication, or the groupcast data communication, or any combination thereof; and receiving a message indicating the PTRS configuration is based at least in part on the UE being part of the multiple groups of UE groups.

Aspect 13: The method of aspect 12, wherein receiving the message indicating the PTRS configuration comprises: receiving a respective message indicating a respective PTRS configuration per group of multiple groups of UE groups, wherein receiving the data communication comprises: receiving the groupcast data communication associated with a respective group of the multiple groups of UE groups based at least in part on the respective PTRS configuration of the respective group.

Aspect 14: The method of any of aspects 12 through 13, wherein each of one or more groups of the multiple groups of UE groups corresponds to a respective group common RNTI.

Aspect 15: The method of aspect 14, further comprising: receiving a downlink control information scheduling a respective data communication for a respective group of the multiple groups of UE groups, wherein receiving the groupcast data communication is based at least in part on the received downlink control information.

Aspect 16: The method of aspect 15, wherein the respective group common RNTI corresponding to the respective group is scrambled with a cyclic redundancy check bit associated with the downlink control information scheduling the respective data communication for the respective group of the multiple groups of UE groups.

Aspect 17: The method of any of aspects 14 through 16, wherein different data communications for each of the one or more groups of the multiple groups of UE groups corresponds to different group common RNTIs.

Aspect 18: A method for wireless communication at a network entity, comprising: determining a PTRS configuration associated with data communication for a plurality of UEs, the data communication comprising a broadcast data communication, a multicast data communication, or a groupcast data communication, or any combination thereof; outputting a PTRS based at least in part on the determined PTRS configuration; and outputting the data communication based at least in part on the determined PTRS configuration.

Aspect 19: The method of aspect 18, wherein outputting the PTRS comprises: broadcasting the PTRS based at least in part on the broadcast data communication.

Aspect 20: The method of any of aspects 18 through 19, wherein outputting the PTRS comprises: transmitting, to the plurality of UEs, the PTRS based at least in part on the multicast data communication, the groupcast data communication, or both.

Aspect 21: The method of any of aspects 18 through 20, further comprising: broadcasting a first message indicating the PTRS configuration.

Aspect 22: The method of any of aspects 18 through 21, further comprising: transmitting, to a group of UEs of the plurality of UEs, a first message indicating the PTRS configuration.

Aspect 23: The method of aspect 22, further comprising: determining a subscription of one or more UEs of the plurality of UEs based at least in part on the multicast data communication, the groupcast data communication, or both, the subscription associated with the group of UEs, wherein outputting the PTRS configuration comprises: transmitting, to the one or more UEs, a second message indicating the PTRS configuration based at least in part on an admittance to the subscription.

Aspect 24: The method of any of aspects 22 through 23, further comprising: receiving a capability report from one or more UEs of the plurality of UEs, the capability report indicating a PTRS capability or a preferred PTRS configuration, wherein determining the PTRS configuration is based at least in part on the capability report.

Aspect 25: The method of any of aspects 22 through 24, further comprising: receiving feedback associated with the PTRS configuration from one or more UEs of the group of UEs, wherein the feedback comprises a decoding failure cause associated with the data communication; and updating the PTRS configuration based at least in part on the received feedback.

Aspect 26: The method of aspect 25, further comprising: transmitting, to the group of UEs of the plurality of UEs, a second groupcast message, a second multicast message, or both, indicating the updated PTRS configuration.

Aspect 27: The method of any of aspects 18 through 26, wherein the PTRS configuration comprises a PTRS data structure for the plurality of UEs, and the PTRS structure is different from a unicast PTRS data structure.

Aspect 28: The method of any of aspects 18 through 27, wherein the PTRS configuration is preconfigured at one or more UEs of the plurality of UEs, the network entity, or both, based at least in part on a capability of the one or more UEs, the network entity, or both.

Aspect 29: An apparatus for wireless communication at a UE, comprising a processor; and a memory coupled with the processor, with instructions stored in the memory, the instructions being executable by the processor to cause the apparatus to perform a method of any of aspects 1 through 17.

Aspect 30: An apparatus for wireless communication at a UE, comprising at least one means for performing a method of any of aspects 1 through 17.

Aspect 31: A non-transitory computer-readable medium storing code for wireless communication at a UE, the code comprising instructions executable by a processor to perform a method of any of aspects 1 through 17.

Aspect 32: An apparatus for wireless communication at a network entity, comprising a processor; and a memory coupled with the processor, with instructions stored in the memory, the instructions being executable by the processor to cause the apparatus to perform a method of any of aspects 18 through 28.

Aspect 33: An apparatus for wireless communication at a network entity, comprising at least one means for performing a method of any of aspects 18 through 28.

Aspect 34: A non-transitory computer-readable medium storing code for wireless communication at a network entity, the code comprising instructions executable by a processor to perform a method of any of aspects 18 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as any combination of computing devices (e.g., any combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
determining a phase tracking reference signal configuration associated with data communication for a plurality of UEs, the data communication comprising a broadcast data communication, a multicast data communication, a groupcast data communication, or any combination thereof;
receiving a phase tracking reference signal based at least in part on the determined phase tracking reference signal configuration; and
receiving the data communication based at least in part on the determined phase tracking reference signal configuration.

2. The method of claim 1, wherein receiving the phase tracking reference signal comprises:
receiving, from a network entity, a broadcast message comprising the phase tracking reference signal based at least in part on the broadcast data communication.

3. The method of claim 1, wherein receiving the phase tracking reference signal comprises:
receiving, from a network entity, a multicast message, a groupcast message, or both, comprising the phase tracking reference signal based at least in part on the multicast data communication, the groupcast data communication, or both.

4. The method of claim 1, further comprising:
receiving, from a network entity, a broadcast message indicating the phase tracking reference signal configuration.

5. The method of claim 1, further comprising:
receiving, from a network entity, a first multicast message, a first groupcast message, or both, indicating the phase tracking reference signal configuration for a group of UEs of the plurality of UEs, the group of UEs comprising at least a subset of the plurality of UEs.

6. The method of claim 5, wherein receiving the phase tracking reference signal configuration is based at least in part on an admittance to a subscription of the group of UEs.

7. The method of claim 5, further comprising:
transmitting a capability report indicating a phase tracking reference signal capability or a preferred phase tracking reference signal configuration,
wherein determining the phase tracking reference signal configuration is based at least in part on the capability report.

8. The method of claim 5, further comprising:
transmitting, to the network entity, feedback associated with the phase tracking reference signal configuration, wherein the feedback comprises a decoding failure cause associated with the data communication.

9. The method of claim 8, further comprising:
receiving, from the network entity, a second groupcast message, a second multicast message, or both, indicating an updated phase tracking reference signal configuration based at least in part on the transmitted feedback.

10. The method of claim 1, wherein:
the phase tracking reference signal configuration comprises a phase tracking reference signal data structure for the plurality of UEs, and
the phase tracking reference signal data structure is different from a unicast phase tracking reference signal data structure.

11. The method of claim 1, wherein the phase tracking reference signal configuration is preconfigured at the UE, a network entity, or both, based at least in part on a capability of the UE, the network entity, or both.

12. The method of claim 1, further comprising:
determining the UE being part of multiple groups of UE groups for the data communication comprising the broadcast data communication, the multicast data communication, or the groupcast data communication, or any combination thereof; and
receiving a message indicating the phase tracking reference signal configuration is based at least in part on the UE being part of the multiple groups of UE groups.

13. The method of claim 12, wherein receiving the message indicating the phase tracking reference signal configuration comprises:
receiving a respective message indicating a respective phase tracking reference signal configuration per group of multiple groups of UE groups, wherein receiving the data communication comprises:
receiving the groupcast data communication associated with a respective group of the multiple groups of UE groups based at least in part on the respective phase tracking reference signal configuration of the respective group.

14. The method of claim 12, wherein each of one or more groups of the multiple groups of UE groups corresponds to a respective group common radio network temporary identifier.

15. The method of claim 14, further comprising:
receiving a downlink control information scheduling a respective data communication for a respective group of the multiple groups of UE groups, wherein receiving the groupcast data communication is based at least in part on the received downlink control information.

16. The method of claim 15, wherein the respective group common radio network temporary identifier corresponding to the respective group is scrambled with a cyclic redundancy check bit associated with the downlink control information scheduling the respective data communication for the respective group of the multiple groups of UE groups.

17. The method of claim 14, wherein different data communications for each of the one or more groups of the multiple groups of UE groups corresponds to different group common radio network temporary identifiers.

18. A method for wireless communication at a network entity, comprising:
determining a phase tracking reference signal configuration associated with data communication for a plurality of user equipments (UEs), the data communication comprising a broadcast data communication, a multicast data communication, or a groupcast data communication, or any combination thereof;
outputting a phase tracking reference signal based at least in part on the determined phase tracking reference signal configuration; and
outputting the data communication based at least in part on the determined phase tracking reference signal configuration.

19. The method of claim 18, wherein outputting the phase tracking reference signal comprises:
broadcasting the phase tracking reference signal based at least in part on the broadcast data communication.

20. The method of claim 18, wherein outputting the phase tracking reference signal comprises:
transmitting, to the plurality of UEs, the phase tracking reference signal based at least in part on the multicast data communication, the groupcast data communication, or both.

21. The method of claim 18, further comprising:
broadcasting a first message indicating the phase tracking reference signal configuration.

22. The method of claim 18, further comprising:
transmitting, to a group of UEs of the plurality of UEs, a first message indicating the phase tracking reference signal configuration.

23. The method of claim 22, further comprising:
determining a subscription of one or more UEs of the plurality of UEs based at least in part on the multicast data communication, the groupcast data communication, or both, the subscription associated with the group of UEs, wherein outputting the phase tracking reference signal configuration comprises:
transmitting, to the one or more UEs, a second message indicating the phase tracking reference signal configuration based at least in part on an admittance to the subscription.

24. The method of claim 22, further comprising:
receiving a capability report from one or more UEs of the plurality of UEs, the capability report indicating a phase tracking reference signal capability or a preferred phase tracking reference signal configuration,
wherein determining the phase tracking reference signal configuration is based at least in part on the capability report.

25. The method of claim 22, further comprising:
receiving feedback associated with the phase tracking reference signal configuration from one or more UEs of the group of UEs, wherein the feedback comprises a decoding failure cause associated with the data communication; and
updating the phase tracking reference signal configuration based at least in part on the received feedback.

26. The method of claim 25, further comprising:
transmitting, to the group of UEs of the plurality of UEs, a second groupcast message, a second multicast message, or both, indicating the updated phase tracking reference signal configuration.

27. The method of claim 18, wherein:
the phase tracking reference signal configuration comprises a phase tracking reference signal data structure for the plurality of UEs, and
the phase tracking reference signal data structure is different from a unicast phase tracking reference signal data structure.

28. The method of claim 18, wherein the phase tracking reference signal configuration is preconfigured at one or more UEs of the plurality of UEs, the network entity, or both, based at least in part on a capability of the one or more UEs, the network entity, or both.

29. An apparatus for wireless communication at a user equipment (UE), comprising:
a processor; and
a memory coupled with the processor, with instructions stored in the memory, the instructions being executable by the processor to cause the apparatus to:
determine a phase tracking reference signal configuration associated with data communication for a plurality of UEs, the data communication comprising a broadcast data communication, a multicast data communication, a groupcast data communication, or any combination thereof;
receive a phase tracking reference signal based at least in part on the determined phase tracking reference signal configuration; and
receive the data communication based at least in part on the determined phase tracking reference signal configuration.

30. An apparatus for wireless communication at a network entity, comprising:
a processor; and
a memory coupled with the processor, with instructions stored in the memory, the instructions being executable by the processor to cause the apparatus to:
determine a phase tracking reference signal configuration associated with data communication for a plurality of user equipments (UEs), the data communication comprising a broadcast data communication, a multicast data communication, or a groupcast data communication, or any combination thereof;
output a phase tracking reference signal based at least in part on the determined phase tracking reference signal configuration; and
output the data communication based at least in part on the determined phase tracking reference signal configuration.
